(19) United States
(12) Patent Application Publication
(10) Pub. No.: US 2007/0063654 A1
(43) Pub. Date: Mar. 22, 2007

(54) Method and apparatus for ionization treatment of gases

(76) Inventor: Vijay K. Mehan, Woodbridge, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/231,714

(22) Filed: Sep. 21, 2005

(51) Int. Cl. H01J 11/00

(52) U.S. Cl. 313/608

(57) ABSTRACT

An electrode assembly for the treatment of gases includes a dielectric housing having an interior area at least partially defined by an interior wall, the interior area being filled with a plasma-forming gas. A first conductor is coupled to the dielectric housing and at least partially extends into the interior area. Upon application of an electric potential to the first conductor, a conducting plasma is formed within the interior area. The conducting plasma contacts substantially all of the interior wall in a substantially uniform manner.

### TECHNICAL FIELD

The present invention is generally related to electrodes for use in creating electric discharges and more specifically to electrodes that employ conducting plasmas, the electrode being used in the ionization treatment of gases.

### BACKGROUND OF THE INVENTION

Dielectric-Barrier discharges (also known as “Surface-Barrier Discharges” or “Silent Discharges” or “Ozonizer Discharges”) are well known to the prior art. Such devices generally consist of an electric discharge energized at high alternating-current voltage between a pair of electrodes, with at least one dielectric barrier interposed between the electrodes, said barrier having sufficient dielectric strength to withstand at least the entire peak-to-peak voltage output from the energizing power supply.

A common arrangement of the prior art high-voltage electrode includes a metal mesh located inside of a sealed dielectric tube which serves as the dielectric barrier. Alternatively, the electrode may be a metal coating disposed on the inside surface of the dielectric tube. A grounded metal sleeve surrounding the dielectric tube and spaced therefrom serves as a second electrode. Depending on the application in which the system is used, there may be a second dielectric tube just inside the metal sleeve, but spaced away from the first dielectric sleeve.

The prior art discloses a generally annular space between the electrode structures filled with a flowing or stationary gas, (depending on the application) at a suitable pressure and flow rate best determined by the parameters of the system. Under such conditions, the electric discharge does not fill the entire annular space, but consists of a multiplicity of brief localized intermittent sparks. A high-voltage alternating-current power supply at a frequency between 50 Hz and 100 kHz is connected to an external terminal of the inner electrode, producing a high electric field between the mesh electrode and the grounded sleeve. When the electric field strength in the gas exceeds the local breakdown field, a discharge occurs, but when the moving charges that carry the current in the discharge arrive at the surface of the insulating dielectric barrier, they cannot pass through it, but pile up on the surface thereof. The resulting surface charge generates a reverse electric field, which cancels the electric field applied by the power supply, and the local discharge extinguishes. Until the reverse field builds up, there is little or no impedance limiting the current flow in the spark other than that of the spark plasma itself, which has a negative resistance. Therefore, the current density in the spark is extremely high and the resulting plasma is dense and energetic. Because of the high current density, the build-up of surface charge on the dielectric is extremely rapid, and the discharge extinction occurs within no more than a few microseconds.

Because each spark is localized, and the surface charge on the dielectric is correspondingly localized, there is no reduction of the applied electric field elsewhere in the inter-electrode gap, and a multiplicity of sparks occurs randomly anywhere within the gap except at the site of a recently-extinguished one.

Because the energizing voltage is alternating, when the phase of the applied voltage is reversed, the electric fields from surface charges residing on the dielectric barrier add to the applied field and facilitate breakdown in the reverse sense. Consequently a quasi-continuous alternating current flows between the two electrodes. This is a conduction current in the gas (the summation of all of the currents in the micro-spark discharges) and a displacement current in the dielectric.

The conducting path of the prior art is a series connection of the resistance of the inner mesh electrode, the capacitance of the dielectric barrier, and the effective resistance of the gaseous conduction of the multiplicity of sparks. In this circuit, the relative impedance of the gaseous conduction and of the dielectric barrier depends on the frequency of the alternating current generated by the high-voltage, high-frequency power supply. A one-meter length of dielectric tube 10 mm OD with a wall thickness of one mm has a capacitance about 560 picofarads. At 60 hertz, this capacitance has an impedance about five megaohms. At 60 kHz, its impedance would be five thousand ohms. The effective resistance of the sparking gas on the other hand, is in the range of one-tenth to one megaohm. By comparison the resistance of the mesh electrode is negligible. Thus, at low frequencies the rms current is controlled by the capacitance of the dielectric, while at high frequencies the behavior of the gas limits the current.

Because of the current-limiting impedance of the dielectric barrier, the rms current through such a discharge device increases with increasing voltage and with increasing frequency. In effect, the dielectric barrier acts as a capacitive ballast. Consequently, such discharge devices are most often operated in parallel banks of hundreds to thousands of individual discharge devices energized from a common power source.

Such discharges are widely used to facilitate chemical reactions in the gas that otherwise would not occur. The inter-electrode space is provided with gas containing stable reaction precursors. These reaction precursors are “activated” in the spark discharges by dissociation or excitation into states that permit rapid reaction; upon extinction of the spark, the energized precursors find themselves in gas at ambient temperature and able promptly to react with their partners, creating the desired product. Since the vast majority of the volume of gas is at ambient temperature at any given time, the reaction products remain intact.

A well-known application for such discharges is in the industrial production of ozone for water treatment. The inter-electrode gap contains flowing air; the oxygen molecules are dissociated in the sparks, and form O₃ (ozone) by reaction in the ambient temperature gas. The system is extremely efficient, with a large fraction of the oxygen being combined to form ozone, and as much as 25% of the electrical energy being consumed in the endothermic ozone-forming reaction.

A more recent application is the use of such discharges in flowing or sealed systems to produce rare-gas-halogen excimer radiations in the ultraviolet. The gas gap includes a rare gas (RG) and a halogen (X) in the form of X₂ or HX. The halogen-containing molecules are dissociated in the sparks and the rare gas is excited to a resonance or metastable state. Upon reaction in the ambient-temperature gas, the mixture forms excited molecules (“excimers”) RGX*. These molecules are stable against chemical dissociation in the excited state, and persist until they lose their excitation energy by dissociative radiation. Since the rare-gas halide molecules are not stable in the ground state, there are no molecules in the gas capable of reabsorbing the radiation emitted by the decaying excited ones. Thus the radiation process is extremely efficient. The overall efficiency of conversion of electrical energy into rare-gas-excimer radiation is in the tens of percent. Excimers have been produced with all of the rare gases combined with all of the halogens.

The prior art is not useful for dielectric-barrier discharges intended to produce radiation, since the metal sleeve would absorb the radiation and prevent its escape. A useful configuration is one in which the outer electrode consists of distilled water in which a few grounded metal wires are disposed. Because of the high dielectric constant of water, the capacitive impedance of the water electrode is small at the excitation frequency of 55 kHz, so that the electric field is uniformly applied across the inter-electrode gap. The water is circulated through the system and used to cool the discharge tube. The distilled water is transparent to the UV radiation, which escapes unhindered.

A problem exists in certain applications in which the gases to be treated are high-temperature corrosive atmospheres. The corrosive atmosphere may weaken the surface of the dielectric sleeve to the extent that it fractures. Fracturing of the sleeve may allow the mesh electrode, at high voltage, to contact the grounded metal sleeve. Since there is no significant impedance in series with the direct short to ground, not only does this permit a destructive high current arc, but also it short-circuits the entire bank of parallel-connected discharge devices. Thus, the failure of a single tube of a parallel-connected bank shuts down the entire bank, causing an outage of the entire unit.

Because of the very high voltages, which are present, conventional fuse wires in series with the high-voltage connection are not successful. When the high current melts the fuse, a metal-vapor arc takes place in the fuse liquid/vapor gap, leaving the circuit still connected. The high-current arc still continues. In recent systems a retractable fuse with mechanical-spring loaded system capable of moving the connecting conductor away from the ground plane has been employed; but such systems are bulky, expensive and unreliable.

Another method used to avoid the problem is to fill the electrode with a conducting liquid such as brine solution and mechanically seal it inside the electrodes. The cooling effect of the liquid might be considered to ameliorate this problem. However, at the temperatures involved (350-450F), the vapor pressure of water is greater than ten atmospheres, much higher than the safe working pressure for quartz, ceramic etc., (150 psi). Tube rupture can result in an explosion.

Based on the foregoing, it is the general object of the present invention to provide an electrode assembly, that improves upon or overcomes the problems and drawbacks associated with the prior art.

### SUMMARY OF THE INVENTION

The present invention resides in one aspect in an electrode assembly for the treatment of corrosive gases, including a dielectric housing which defines an interior area at least partially defined by an interior wall. The interior area is filled with a plasma-forming gas. A first conductor is coupled to the dielectric housing and at least partially extends into the interior area of the dielectric housing. Upon application of an electric potential to the first conductor, the plasma-forming gas is transformed into a conducting plasma which then contacts substantially all of the interior wall of the dielectric housing in a substantially uniform manner.

In a preferred embodiment of the present invention an outer housing is provided that includes an interior passage defined by a conductive wall. The dielectric housing is located at least partially within the interior passage so that the dielectric housing and conductive wall cooperate to define a gap therebetween. An end of the dielectric housing associated with the first conductor, extends outwardly from the passage. During operation, formation of the conducting plasma causes a multiplicity of electric discharges to arc between the dielectric housing and the conductive wall.

Paschen's Law essentially states that the breakdown characteristics of a gap are a function of the product of the gas pressure and the gap length, usually written as V=f(pd), where p is the gas pressure and d is the gap distance. Therefore in certain embodiments of the present invention, the end of the dielectric housing associated with the first conductor extends outwardly from the interior passage by a predetermined distance. The distance is designed to be greater than the distance at which breakdown can occur at an applied voltage and a pressure of the gas to be treated.

Other embodiments of the present invention may include a plurality of the electrode assemblies. At least a portion of the plurality of the electrode assembles can be connected to a common power supply. The plurality of electrode assemblies can be arranged in an array.

Preferably the dielectric housing is hermetically sealed. The plasma forming gas can be one or a combination of krypton, neon, argon and xenon, however the invention is not limited in this regard as other gases known to those skilled in the pertinent art to which the present invention pertains can be substituted without departing from the broader aspects of the present invention. A combination of about 79% neon, about 20% argon and about 1% xenon, by volume, is particularly effective for use as the plasma-forming gas. The plasma-forming gas can be at a pressure of about 9 torr to 200 torr and preferably at about 70 torr. The dielectric housing can be fabricated from fused quartz.

The first conductor can be in the form of at least one wire, preferably with at least a portion of the first conductor that extends into the interior area being a hollow shell. At least a portion of the first conductor that extends into the interior area can be hermetically sealed within the interior area of the dielectric housing. The first conductor can be a refractory metal such as molybdenum, nickel plated steel or nickel. The first conductor can be at least partially coated with a coating of alkaline earth oxides.

The present invention resides in another aspect, in a method for the treatment of gases, wherein an electrode assembly of the above described type is provided. During operation, an high voltage alternating electric potential, preferably, but not limited to a saw tooth wave shape, is applied to the first conductor thereby causing formation of a conducting plasma within the interior area. Once formed, the conducting plasma contacts substantially all of the interior wall of the dielectric housing in a substantially uniform manner. This causes a multiplicity of electric discharges to be generated between the dielectric housing and the conductive wall. The gases are ionized by the electric discharges as the gases flow through the gap between the dielectric housing and the conductive wall. In certain embodiments of the present invention the corrosive gasses may be treated. In other embodiments gases may be treated wherein the dielectric housing is at an operating temperature of at least 200° F.

### BRIEF DESCRIPTION OF THE DRAWINGS

FIG. 1 is a cross sectional view of an embodiment of the electrode assembly of the present invention.

FIG. 2 is a cross sectional view of a plurality of electrode assemblies.

FIG. 3 is a partial cross sectional view of the electrode assembly of FIG. 1, showing the first conductor as a wire.

FIG. 4 is a partial cross sectional view of the electrode assembly of the present invention showing at least a portion of the first conductor that extends into the interior area of the dielectric housing as a hollow shell.

FIG. 5 is a schematic illustration of the electrode assembly of the present invention.

### DETAILED DESCRIPTION OF THE PREFERRED EMBODIMENT

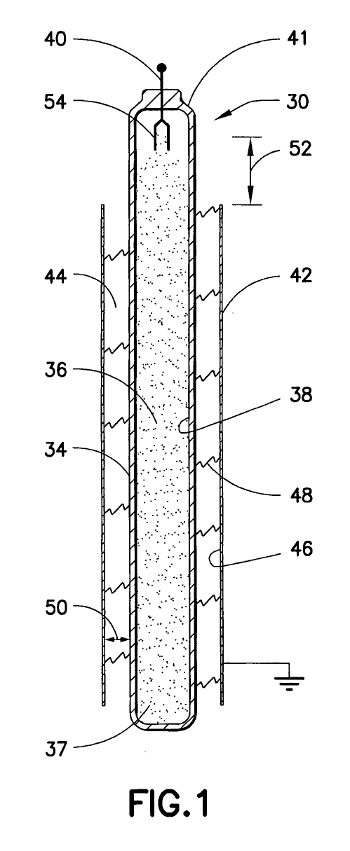

As shown in FIG. 1, an electrode assembly for the treatment of gases, including but not limited to corrosive gases, is generally described by the reference number 30. The electrode assembly 30 includes a dielectric housing 34 having an interior area 36 at least partially defined by an interior wall 38. The interior area 36 is filled with a plasma-forming gas 37. A first conductor 40 is coupled to the dielectric housing 34 and at least partially extends into the interior area 36.

The electrode assembly of the present invention includes an outer housing 42 having an interior passage 44 defined by a conductive wall 46. The end 41 of the dielectric housing 34 associated with the first conductor 40 extends outwardly from the interior passage 44 as represented by the distance 52. The distance 52 is designed to be greater than the distance at which breakdown can occur at an applied voltage and a pressure of the corrosive gas. The plasma-forming gas 37 can include one or a combination of krypton, neon, argon and xenon. Preferably, the plasma-forming gas 37 is about 79% neon, about 20% argon and about 1% xenon, by volume. The plasma-forming gas 37 can be at a pressure of about 9 to 200 torr. Preferably, the plasma-forming gas can also be at a pressure of about 70 torr. In the illustrated embodiment, the dielectric housing 34 is hermetically sealed and may be fabricated from fused quartz.

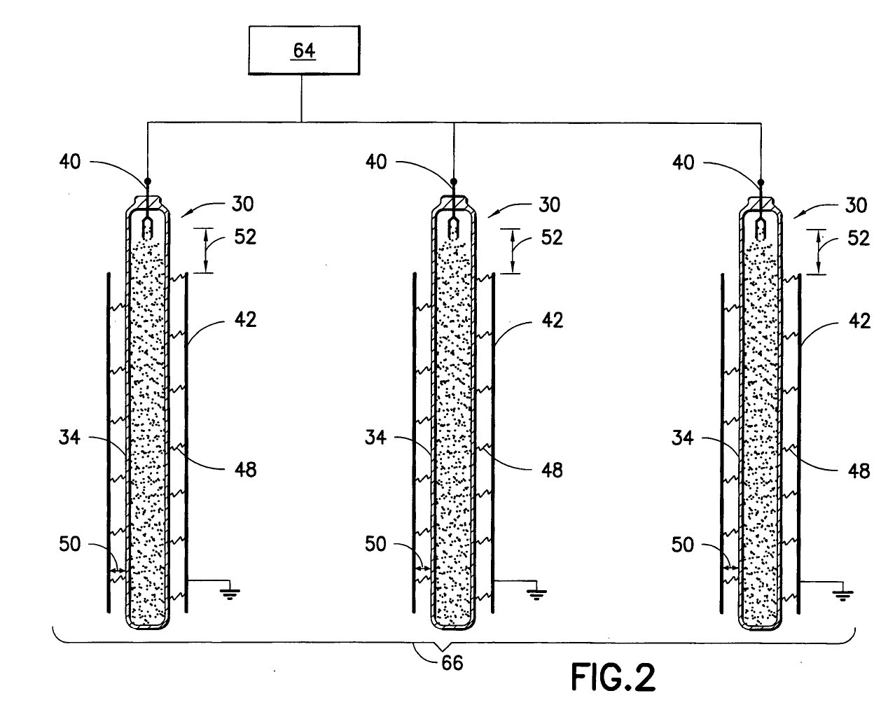

As shown in FIG. 2 a plurality of the electrode assemblies 30 can be electrically connected to a common power supply 64. The plurality of electrode assemblies are further positioned to form an array 66.

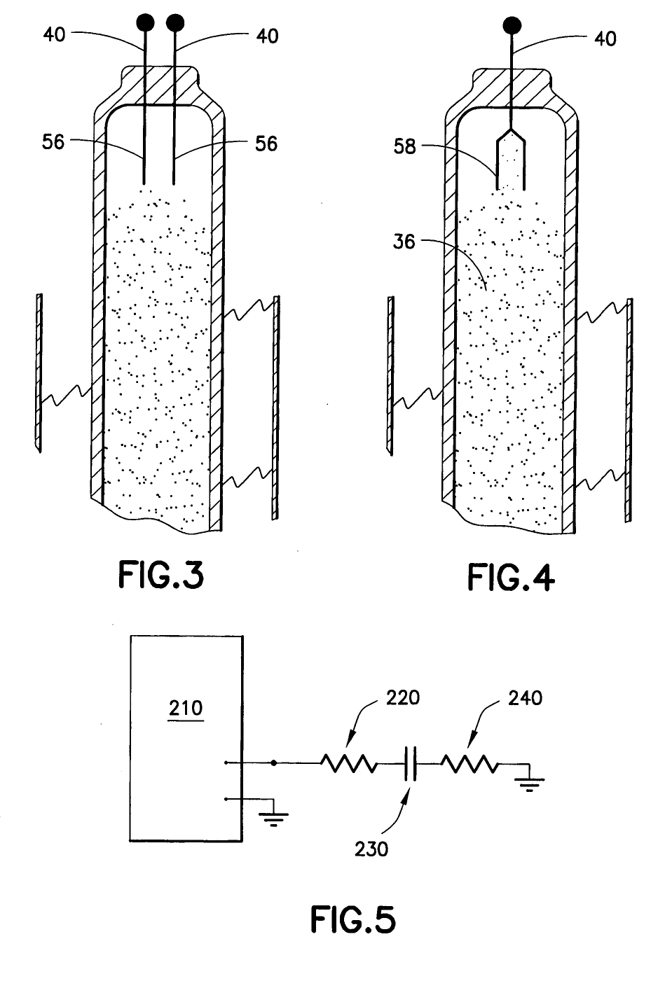

As shown in FIG. 3, a portion of the first conductor 40, in the illustrated embodiment, is at least one wire 56. Turning to FIG. 4, at least a portion of the first conductor 40, positioned in the interior area 36 is a hollow shell 58. The first conductor 40 may a refractory material including molybdenum, nickel plated steel, nickel or other suitable material known to those skilled in the pertinent art relevant to the present invention. The first conductor 40 may also be at least partially coated with a coating of alkaline earth oxides.

The present invention finds utility in treating corrosive gases with an electrode assembly of the above described type by providing an electric potential to a first conductor coupled to a dielectric housing filled with a plasma-forming gas, the plasma-forming gas being contained within an interior wall of the dielectric housing. The electrode assembly includes an outer housing, having an interior passage defined by a conductive wall. The dielectric housing extends outwardly from the interior passage. Mirror-image surface charges on the interior wall result from a second surface charge on the dielectric housing. The mirror-image surface charges cause formation of a conducting plasma within an interior area of the dielectric housing. The mirror-image surface charges provide for propagation of the conducting plasma within the interior area of the dielectric housing. The conducting plasma contacts substantially all of the interior wall of the dielectric housing in a substantially uniform manner. The plasma-forming gas is at a predetermined pressure to attain a uniform glow of the conducting plasma. A spacing between the outer housing and the conductive wall cooperate to define a gap therebetween, so that during operation, formation of the conducting plasma causes a multiplicity of electric discharges to arc between the dielectric housing and the conductive wall. The multiplicity of electric charges ionize the corrosive gases as the gases flow through the gap. Depending on the volume of corrosive gas to be treated, a plurality of the electrode assemblies can be arranged in an array. When the plurality of electrode assemblies are electrically connected in an array, they are powered with one common power supply. When the electrode assemblies are arranged in an array, the failure of one or more of the electrode assemblies does not cause the remaining electrode assemblies to cease operation.

The method of operation of the electrode assembly is further illustrated by FIG. 5. The electrical circuit diagram of FIG. 5 shows a power supply 210, a series connection of a non-zero resistance 220 of the conducting plasma, the capacitance 230 of the dielectric barrier, and the effective resistance 240 of the gaseous conduction of the multiplicity of sparks.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof.

Therefore, it is intended that the invention not be limited to the particular embodiments disclosed in the above detailed description, but that the invention will include all embodiments falling within the scope of the appended claims.

What is claimed is:

1. An electrode assembly for treatment of gases, comprising:
a dielectric housing having an interior area at least partially defined by an interior wall;
said interior area being filled with a plasma-forming gas;
a first conductor coupled to said dielectric housing and at least partially extending into said interior area;
and wherein upon application of an electric potential to said first conductor, the plasma-forming gas is converted to a conducting plasma within said interior area; said conducting plasma contacting substantially all of said interior wall in a substantially uniform manner.

2. The electrode assembly of claim 1, further comprising:
an outer housing having an interior passage defined by a conductive wall, said dielectric housing at least partially extending into said interior passage; and wherein
said dielectric housing and said conductive wall cooperate to define a gap therebetween, so that during operation, formation of said conducting plasma causes a multiplicity of electric discharges to arc between said dielectric housing and said conductive wall.

3. The electrode assembly of claim 2, further comprising a plurality of said electrode assemblies.

4. The electrode assembly of claim 3, wherein at least a portion of said plurality of said electrode assemblies is connected to a common power supply.

5. The electrode assembly of claim 1, wherein the dielectric housing is hermetically sealed.

6. The electrode assembly of claim 1, wherein said plasma-forming gas includes at least one of krypton, neon, argon and xenon.

7. The electrode assembly of claim 6, wherein said plasma-forming gas is about 79% neon, about 20% argon and about 1% xenon, by volume.

8. The electrode assembly of claim 1, wherein said plasma-forming gas is at a pressure of at least about 9 torr to about 200 torr.

9. The electrode assembly of claim 8, wherein said plasma-forming gas is at a pressure of about 70 torr.

10. The electrode assembly of claim 1, wherein said first conductor is at least one wire.

11. The electrode assembly of claim 1, wherein at least a portion of said first conductor that extends into said interior area is a hollow shell.

12. The electrode assembly of claim 1, wherein said first conductor is nickel plated steel.

13. The electrode assembly of claim 1, wherein said first conductor is nickel.

14. The electrode assembly of claim 1, wherein said first conductor is a refractory metal.

15. The electrode assembly of claim 1, wherein said first conductor is molybdenum.

16. The electrode assembly of claim 1, wherein said first conductor is at least partially coated with alkaline earth oxides.

17. The electrode assembly of claim 1, wherein said dielectric housing is fabricated from fused quartz.

18. The electrode assembly of claim 2, wherein an end of said dielectric housing associated with said first conductor extends outwardly from said interior passage.

19. A method for the treatment of gases, said method comprising the steps of:
providing an electrode assembly comprising
a dielectric housing defining an interior area filled with a plasma-forming gas;
a first conductor coupled to said dielectric housing and at least partially extending into said interior area;
said dielectric housing having an interior wall that at least in part defines said interior area;
an outer housing having an interior passage defined by a conductive wall; and
the dielectric housing at least partially extending into said interior passage;
positioning an end of said dielectric housing associated with said first conductor outwardly from said interior passage; and positioning said dielectric housing such that a gap is defined between said conductive wall and said dielectric housing;
providing an electric potential to said first conductor thereby causing formation of a conducting plasma within said interior area; said conducting plasma contacting substantially all of said interior wall in a substantially uniform manner; and further causing a multiplicity of electric discharges between said dielectric housing and said conductive wall; and
ionizing gases by flowing said gases through said gap thereby exposing said gases to said multiplicity of electric discharges.

20. The method for the treatment of gases of claim 19, wherein said step of providing an electrode assembly includes providing said plasma-forming gas at a predetermined pressure to attain a uniform glow of said conducting plasma.

21. The method for the treatment of gases of claim 19, wherein said plasma-forming gas is at least one of krypton, neon, argon and xenon.

22. The method for the treatment of gases of claim 19, wherein said plasma-forming gas is about 79% neon, about 20% argon and about 1% xenon, by volume.

23. The method for the treatment of gases of claim 19, wherein said step of providing said plasma-forming gas includes providing said plasma-forming gas at a pressure of at least 9 torr.

24. The method for the treatment of gases of claim 19, wherein said step of providing said plasma-forming gas includes providing said plasma-forming gas at a pressure of about 9 torr to about 200 torr.

25. The method for the treatment of gases of claim 19, wherein said step of providing an electric potential to said first conductor thereby causing formation of a conducting plasma within said interior area includes the steps of establishing mirror-image surface charges on said interior wall;
said mirror-image charges induced by a second surface charge on said dielectric housing, said mirror-image surface charges providing for propagation of said conducting plasma within said dielectric housing.

26. The method for the treatment of gases of claim 19, wherein said step of providing an electrode assembly includes the steps of providing a plurality of said electrode assemblies, connecting at least a portion of said plurality of said electrode assemblies to a common power supply and assembling said plurality of said electrode assemblies in an array.

27. The method for the treatment of gasses of claim 26, wherein said at least a portion of said plurality of said electrode assemblies remain operational following a failure of at least one of said dielectric housings.

28. The method for the treatment of gases of claim 19, wherein the step of ionizing gases further includes the step of ionizing corrosive gasses.

29. The method for the treatment of gases of claim 19, wherein the step of ionizing gasses further includes the step of ionizing gases wherein the dielectric housing is at an operating temperature of at least 200° F.
